(19) United States
(12) Patent Application Publication
(10) Pub. No.: US 2022/0190864 A1
(43) Pub. Date: Jun. 16, 2022

(54) CASE FOR A MOBILE COMMUNICATIONS DEVICE

(71) Applicant: TECH 21 LICENSING LIMITED, Middlesex (GB)

(72) Inventors: Henry Alistair Calum PROUT, Middlesex (GB); Tom HOWARD, Middlesex (GB)

(21) Appl. No.: 17/118,661

(22) Filed: Dec. 11, 2020

(51) Int. Cl. H04B 1/3888

(52) U.S. Cl. CPC H04B 1/3888

(57) ABSTRACT

A case for a mobile communications device is provided that has a rear wall with two upstanding side walls and two upstanding end walls. The walls define a cavity for the mobile communications device. Four corner regions are define, each, at an interface between a respective side wall and a respective end wall. The case has a depth dimension perpendicular to the rear wall and a perimeter dimension perpendicular to the depth dimension. At least one of the side walls is provided with a plurality of first air pockets arranged along the respective side wall. Each first air pocket faces the cavity and is open on the side facing the cavity and is closed on the opposite side. Each first air pocket is longer in the perimeter dimension than the depth dimension. At least one of the end walls is provided with a plurality of second air pockets arranged along the length of the respective end wall. Each second air pocket faces the cavity and is open on the side facing the cavity and is closed on the opposite side. Each second air pocket is longer in the perimeter dimension than the depth dimension. A plurality of ribs are in the corner regions and extend into the cavity, wherein the spacing of the ribs in the perimeter dimension is less than the perimeter dimension at least one of the first or second air pockets.

### FIELD OF THE INVENTION

The present invention relates to a case for a mobile communications device such as a mobile phone or tablet.

### BACKGROUND

Devices are now being produced which will connect to a 5G network. The case is particularly designed for such a device.

In our previous application GB2533828, we disclose a case suitable for use with a pre-5G signal. Such devices are provided with an RF antenna to receive the signal. The case is provided with a region in the vicinity of the antenna which has an opening, recess or low dielectric parameter so as to minimise the loss of signal to the antenna.

Mobile devices which receive a 5G signal pose a different challenge in that there is no discrete RF antenna. Instead, the 5G signal is affected by the presence of the case at any part of the device.

This provides a challenge to a designer in that the desire to protect the mobile device by providing enhanced cushioning around the device conflicts with the need not to have an unduly adverse effect on the 5G reception.

### SUMMARY OF THE INVENTION

The present invention is directed to a case for which addresses issues of prior art devices.

According to the present invention, there is provided a case according to claim 1.

For these purposes, the spacing of the ribs is measured as the distance between the centre of the crests of adjacent ribs. The length of the air pocket in the perimeter direction is measured as an internal measurement of the air pockets in the perimeter direction at the longest part of that pocket.

The present invention therefore proposes a case which has a number of relatively long air pockets extending along at least one side wall and at least one end wall. In practice, with current phone designs, it is likely that the air pockets will extend along the majority of both side walls, at least for the parts of the phone which do not contain other features such as buttons or openings to interact with the mobile device. The end air pockets may extend only along one of the end walls corresponding to the top of the phone as the opposite end wall of the case is a largely open structure in order to accommodate the charging port and speaker of the phone. However, this may change as the design of the phones evolves.

The relatively long air pockets provide improved 5G signal transmission as compared to conventional cases which either have continuous contact between the case and the walls of the mobile communications device, or have a number of relatively closely spaced ribs.

On the other hand, the corners of the mobile communications device are most susceptible to damage as any case which is dropped is most likely to land on a corner. In the corner regions, therefore, the case provides enhanced protection in the form of the more closely spaced ribs. These regions represent only a small part of the case such that any loss of the transmission of the 5G signal is acceptable.

The length of the first and second air pockets is preferably significantly larger than the spacing of the ribs. In particular, preferably, the spacing of the ribs is less than half and more preferably less than a third of the longest length of the longest of the air pockets.

Further, preferably, the length of the pocket is significantly greater than the width. Preferably the maximum length is at least twice the maximum width for an air pocket.

In the above, the length of the air pockets is measured in the perimeter dimension and the width is measured in the depth dimension.

The air pockets along the side and end walls are separated by partitions. The air pocket should take up a substantial portion of the respective end or side wall, such that the minimum length of a partition in the perimeter dimension is less than half and preferably less than a third of the maximum length of an adjacent air pocket.

The air pockets preferably have a continuous upper edge extending around the entire periphery of the pocket which is configured to abut the side of a mobile communication device in the case. This creates a closed air pocket, in use, which provides an air cushioning effect in the event of an impact.

The ends of the air pockets may create a rectangular air pocket. However, preferably, the ends of each air pocket are curved as this helps with mould flow in the injection moulding and avoids air traps in the finished product.

The maximum length (i.e. the dimension in the perimeter dimension) of at least one of the air pockets is greater than 5 mm and preferably greater than 8 mm.

There are preferably between four and six first air pockets on a side wall and preferably between two and four second air pockets on an end wall.

Preferably, the length (i.e the perimeter dimension) of at least one of the first air pockets is greater than the length of at least one of the second air pockets. Because of the weighting of a typical mobile device, it is more likely to land on an end than a side. Providing shorter pockets at the ends, provides enhanced impact resistance as compared to the sides, but less good 5G transmission. However, because the end walls are shorter than the side walls, the additional impact protection provided by the shorter air pockets justifies the small reduction in the 5G performance.

The rear wall may be devoid of features. However, again, this is preferably provided with a feature which will enhance 5G transmission. Preferably, greater than 50% of the area of the rear wall is provided with a groove pattern, the groove pattern comprising a plurality of elongate straight grooves which are substantially parallel to one another and extend in a single direction. Having a large portion of the rear wall of the case taken up in such a groove structure improves the 5G transmission as the signal can be effected by a torturous arrangement of grooves, but is far less affected by the parallel straight grooves as set out above.

The grooves may be provided with the outer face of the rear wall, but are preferably provided on the face of the rear wall which faces the cavity. The grooves may be provided on both sides.

The grooves could be relatively short, but the best performance has been found to be provided by a longer groove. As such, at least one of the grooves has a length which is longer than the length of an inner face of the end wall in the perimeter dimension. In practice, this means that the grooves extend diagonally across the rear wall.

The case may be formed of a number of different materials. For example, there may be a softer material lining the walls to provide an improved cushioning effect. However, preferably, the end walls and the side walls are formed of a single material. More preferably, the case is made of a single material.

The present invention is well suited to such a structure as the air pockets provide a degree of cushioning and hence impact resistance which compensates for the absence of a softer cushioning material. The resulting case can be a low cost item which provides good impact resistance as well as low 5G interference.

### BRIEF DESCRIPTION OF THE DRAWINGS

An example of a case in accordance with the present invention will now be described with reference to the accompanying drawings in which:

FIG. 1 is a perspective view of the case; and

FIG. 2 is a partial perspective view from the opposite side of the case.

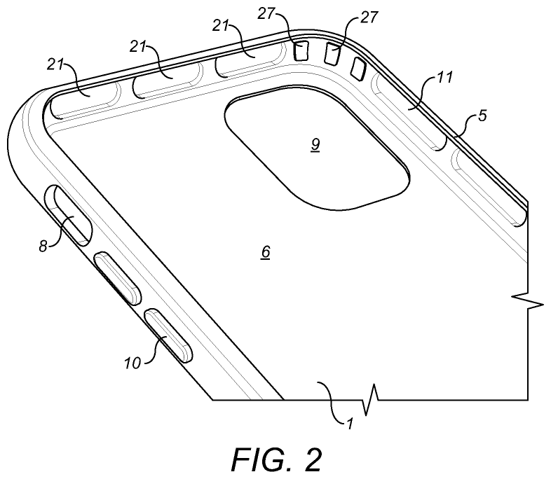

### DETAILED DESCRIPTION

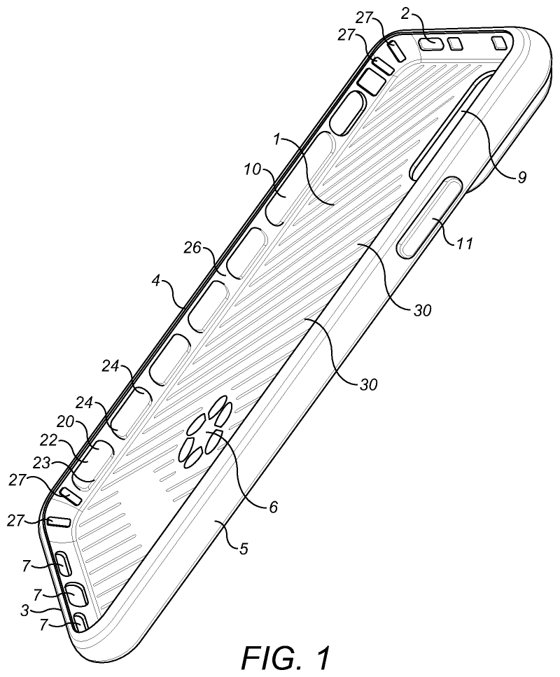

The case shown in FIG. 1 is injection moulded from a single material. It could, however, be formed of a number of different materials and/or be formed by some other method such as 3D printing.

The illustrated case has been designed for a mobile phone, but can be easily adapted for other purposes such as a tablet.

The case has a generally rectangular configuration. It has a rear wall 1. Along the shorter sides of the case are a pair of upstanding end walls in the form of a top wall 2 and a bottom wall 3. Along the longer side of the care are a pair of upstanding side walls in the form of a first side wall 4 and a second side wall 5. The walls 1-5 define a cavity 6 for receiving a mobile phone device in the conventional manner.

The case has a number of additional conventional features such as a number of ports 7 in the bottom wall 3 that allow access to a charging port and speakers. A port 8 is provided in the first side wall 4 to allow access to a switch on the side of the mobile phone device. A port 9 is provided in the rear wall 1 to provide access to the camera lens and its associated features. Flexible inserts 10 and 11 are provided in the first 4 and second 5 side walls respectively such that they can be manipulated to operate the underlying buttons and the mobile phone device. These are all conventional features and variations of these can be provided to accommodate the different requirements of the particular device.

The case is provided with a number of features designed to improve the 5G transmission to the mobile phone device held in the case.

A number of side air pockets 20 are provided in the inner face of the first 4 and second 5 side walls facing the cavity. Similar end pockets 21 are provided in the top wall 2. Depending on the design of the mobile phone device, the air pockets may also be provided in the bottom wall 3. However, in the present case, there is no space for any such air pockets given the presence of the ports 7.

The side air pockets 20 and end air pockets 21 have essentially the same construction and will be described below. However, the end air pockets 21 are shorter than the side air pockets 20.

Each of the air pockets 20, 21 is a shallow elongate pocket that is open to the cavity 6. The air pocket does not extend through to the opposite side of its associated wall. Each of the air pockets has an elongate upper edge 22 and an elongate lower edge 23. The edges 22 and 23 are connected at each end by a curved edge 24.

The air pockets 20, 21 are designed with a number of factors in mind.

Because they have a relatively long configuration and extend for the majority of the respective wall 2, 4, 5 away from the corners and any other ports or inserts, they extend along a significant portion of the sides of the mobile communication device.

These sides are therefore, to a large extent, adjacent to an air pocket 20, 21 rather than being in direct contact with the part of the case such as a rib 26 between adjacent air pockets 20, 21. Because air has a lower permittivity than the plastic material forming the case, this has a reduced effect on the interference with the 5G RF signal. The case therefore improves the signal transmission of the mobile communication device.

The side walls 4,5 extend along the parts of the case which are least likely to receive an impact for use. Therefore, the side wall air pockets 20 are longer than the end pockets 21. These shorter pockets provide better impact protection.

Some of the impact protection is provided by the nature of the air pockets themselves. The pockets are surrounded by a continuous lip of the elongate upper edge 22, elongate lower edge 23 and curved edges 24. This lip is configured to be in close proximity with the side of the mobile device. This does not form a perfect seal, but does ensure that, in the event of an impact, air is trapped to a large extent within the air pocket by the mobile device itself which provides an air cushioning air effect in these regions. The same effect does not occur in a convention ribbed structure where there is less air because the ribs are closer together and there is a larger path between adjacent ribs along which the air can escape following an impact. This is done because in the conventional case it is the ribs themselves which primarily provide the impact resistance, rather than any air cushioning.

The air pockets 20, 21 provide additional benefits as they require less material than a continuous or ribbed structure and therefore reduce the cost and weight of the case.

The corner regions are provided with a number of inwardly extending ribs 27 in order to provide enhanced impact protection in these regions. These are much more closely spaced than the ribs 26 adjacent to the air pockets. This provides enhanced impact protection for the more vulnerable corners. However, as they are confined to a relatively small proportion of the surface area of the mobile device, the additional material in contact with the device in these regions has only a small detrimental effect on the transmission of the 5G signal.

The rear wall 1 is provided with a number of diagonal parallel elongate grooves 30 which cover at least 50% of the area of the rear wall. As shown in FIG. 1, there are certain areas where logos and writing are present but the ribs are absent. The grooves again take advantage of the improved dielectric characteristic of air as opposed to the plastics material of the case thererby improving the 5G transmission. The grooves are straight, parallel and only extend in a single direction which again enhances the 5G transmission as a more complex groove design would interfere to a greater extent with the 5G signal.

1. A case for a mobile communications device, the case comprising a rear wall with two upstanding side walls and two upstanding end walls, the walls defining a cavity for the mobile communications device, the side walls are transverse to the end walls;
four corner regions being defined each at an interface between a respective side wall and a respective end wall;
the case having a depth dimension perpendicular to the rear wall and a perimeter dimension perpendicular to the depth dimension;
wherein at least one of the side walls is provided with a plurality of first air pockets arranged along the respective side wall, each first air pocket facing the cavity and being open on the side facing the cavity and closed on the opposite side, each first air pocket being longer in the perimeter dimension than the depth dimension;
at least one of the end walls is provided with a plurality of second air pockets arranged along the respective end wall, each second air pocket facing the cavity and being open on the side facing the cavity and closed on the opposite side, each second air pocket being longer in the perimeter dimension than the depth dimension;
and a plurality of ribs in the corner regions, the ribs extending into the cavity, wherein the spacing of the ribs in the perimeter dimension is less than the perimeter dimension at least one of the first or second air pockets.

2. The case for a mobile communications device according to claim 1, wherein the spacing of the ribs is less than half of the longest length of the longest of the air pockets.

3. The case for a mobile communications device according to claim 2, wherein the spacing of the ribs is less than a third of the longest length of the longest of the air pockets.

4. The case for a mobile communications device according to claim 1, wherein the maximum length is at least twice the maximum width for an air pocket.

5. The case for a mobile communications device according to claim 1, wherein the minimum length of a partition between air pockets in the perimeter dimension is less than half of the maximum length of an adjacent air pocket.

6. The case for a mobile communications device according to claim 5, wherein the minimum length of a partition between air pockets in the perimeter dimension is less than a third of the maximum length of an adjacent air pocket.

7. The case for a mobile communications device according to claim 1, wherein the air pockets have a continuous upper edge extending around the entire periphery of the pocket which is configured to abut the side of a mobile communication device in the case, in use.

8. The case for a mobile communications device according to claim 1, wherein the ends of each air pocket are curved.

9. The case for a mobile communications device according to claim 1, wherein the maximum length of at least one of the air pockets is greater than 5 mm.

10. The case for a mobile communications device according to claim 1, wherein the maximum length of at least one of the air pockets is greater than 8 mm.

11. The case for a mobile communications device according to claim 1, wherein there are between four and six first air pockets on a side wall.

12. The case for a mobile communications device according to claim 1, wherein there are between two and four second air pockets on an end wall.

13. The case for a mobile communications device according to claim 1, wherein the length of at least one of the first air pockets is greater than the length of at least one of the second air pockets.

14. The case for a mobile communications device according to claim 1, wherein greater than 50% of the area of the rear wall is provided with a groove pattern, the groove pattern comprising a plurality of elongate straight grooves which are substantially parallel to one another and extend in a single direction.

15. The case for a mobile communications device according to claim 14, wherein the grooves are provided on the face of the rear wall which faces the cavity.

16. The case for a mobile communications device according to claim 15, wherein at least one of the grooves has a length which is longer than the length of an inner face of the end wall.

17. The case for a mobile communications device according to claim 1, wherein the end walls and the side walls are formed of a single material.

18. The case for a mobile communications device according to claim 17, wherein the case is made of a single material.
